(19) United States
(12) Patent Application Publication
(10) Pub. No.: US 2016/0162124 A1
(43) Pub. Date: Jun. 9, 2016

(54) METHOD AND SYSTEM FOR ACCOUNT AUTHENTICATION VIA E-LIBRARY VIEW INTERFACE

(71) Applicant: Kobo Incorporated, Toronto (CA)

(72) Inventor: Hufsa TAHIR, Mississauga (CA)

(73) Assignee: KOBO INCORPORATED, Toronto (CA)

(21) Appl. No.: 14/559,478

(22) Filed: Dec. 3, 2014

(51) Int. Cl. G06F 3/0482; H04L 29/06; G06F 3/0484; G06F 3/0488; G06F 3/0481; G06F 3/0483

(52) U.S. Cl. CPC G06F 3/0482; G06F 3/04817; G06F 3/0483; G06F 3/04842; G06F 3/04883; H04L 63/10

(57) ABSTRACT

A method and system for authenticating a user a computing device for accessing an e-library account. The method comprises displaying icons representing a plurality of electronic books (e-books) at the display screen, a first set of the icons representing respective ones of a first set of e-books from a first source, the first source being in a locked access state relative to a request for access received at the computing device. The first set of icons are interspersed within a second set of the icons representing respective ones of a second set of e-books from a second source. Then in response to a state change request received at the computing device, generating a notification inviting selection of the ones of the first set of icons. In response to respective inputs received at the display screen identifying the interspersed first set of icons, unlocking the locked access state of the first source to grant the request for access thereto.

### TECHNICAL FIELD

Examples described herein relate to a system and method for operating a computing device in providing a e-library view logic interface for digital reading (e-reading).

### BACKGROUND

An electronic personal display is a mobile computing device that displays information to a user. While an electronic personal display may be capable of many of the functions of a personal computer, a user can typically interact directly with an electronic personal display without the use of a keyboard that is separate from, or coupled to, but distinct from the electronic personal display itself. Some examples of electronic personal displays include mobile digital devices/tablet computers and electronic readers (e-readers) such (e.g., Apple iPad®, Microsoft® Surface™, Samsung Galaxy Tab® and the like), handheld multimedia smartphones (e.g., Apple iPhone®, Samsung Galaxy S®, and the like), and handheld electronic readers (e.g., Amazon Kindle®, Barnes and Noble Nook®, Kobo Aura HD, Kobo Aura H2O, Kobo GLO and the like).

Some electronic personal display devices are purpose built devices designed to perform especially well at displaying digitally stored content for reading or viewing thereon. For example, a purpose build device may include a display that reduces glare, performs well in high lighting conditions, and/or mimics the look of text as presented via actual discrete pages of paper. While such purpose built devices may excel at displaying content for a user to read, they may also perform other functions, such as displaying images, emitting audio, recording audio, and web surfing, among others.

Electronic personal displays are among numerous kinds of consumer devices that can receive services and utilize resources across a network service. Such devices can operate applications or provide other functionality that links a device to a particular account of a specific service. For example, the electronic reader (e-reader) devices typically link to an online bookstore, and media playback devices often include applications that enable the user to access an online media electronic library (or e-library). In this context, the user accounts can enable the user to receive the full benefit and functionality of the device.

Yet further, such devices may incorporate a touch screen display having integrated touch sensors and touch sensing functionality, whereby user input commands via touch-based gestures are received thereon.

### BRIEF DESCRIPTION OF THE DRAWINGS

The accompanying drawings, which are incorporated in and form a part of this specification, illustrate various embodiments and, together with the Description of Embodiments, serve to explain principles discussed below. The drawings referred to in this brief description of the drawings should not be understood as being drawn to scale unless specifically noted.

FIG. 1 illustrates a system utilizing applications and providing e-book services on a computing device configured for operation in authenticating a user for accessing a locked state e-library account via an e-library view interface, in an embodiment.

FIG. 2 illustrates a schematic architecture and configuration of a computing device configured for authenticating a user for accessing a locked state e-library account via an e-library view interface, according to an embodiment.

FIG. 3 illustrates an example configuration for operation in authenticating a user for accessing a locked state e-library account via an e-library view interface, according to an embodiment.

FIG. 4 illustrates a method for operation in authenticating a user for accessing a locked state e-library account via an e-library view interface on a computer device having a touchscreen display, according to an embodiment.

### DETAILED DESCRIPTION

“E-books” are a form of electronic publication content stored in digital format in a computer non-transitory memory, viewable on a computing device having display functionality. An e-book can correspond to, or mimic, the paginated format of a printed publication for viewing, such as provided by printed literary works (e.g., novels) and periodicals (e.g., magazines, comic books, journals, etc.). Optionally, some e-books may have chapter designations, as well as content that corresponds to graphics or images (e.g., such as in the case of magazines or comic books). Multi-function devices, such as cellular-telephony or messaging devices, can utilize specialized applications (e.g., specialized e-reading application software) to view e-books in a format that mimics the paginated printed publication. Still further, some devices (sometimes labeled as “e-readers”) can display digitally-stored content in a more reading-centric manner, while also providing, via a user input interface, the ability to manipulate that content for viewing, such as via discrete pages arranged sequentially (that is, pagination) corresponding to an intended or natural reading progression, or flow, of the content therein.

An “e-reading device”, variously referred to herein as an electronic personal display or mobile computing device, can refer to any computing device that can display or otherwise render an e-book. By way of example, an e-reading device can include a mobile computing device on which an e-reading application can be executed to render content that includes e-books (e.g., comic books, magazines, etc.). Such mobile computing devices can include, for example, a multi-functional computing device for cellular telephony/messaging (e.g., feature phone or smart phone), a tablet computer device, an ultra-mobile computing device, or a wearable computing device with a form factor of a wearable accessory device (e.g., smart watch or bracelet, glass-wear integrated with a computing device, etc.). As another example, an e-reading device can include an e-reader device, such as a purpose-built device that is optimized for an e-reading experience (e.g., with E-ink displays).

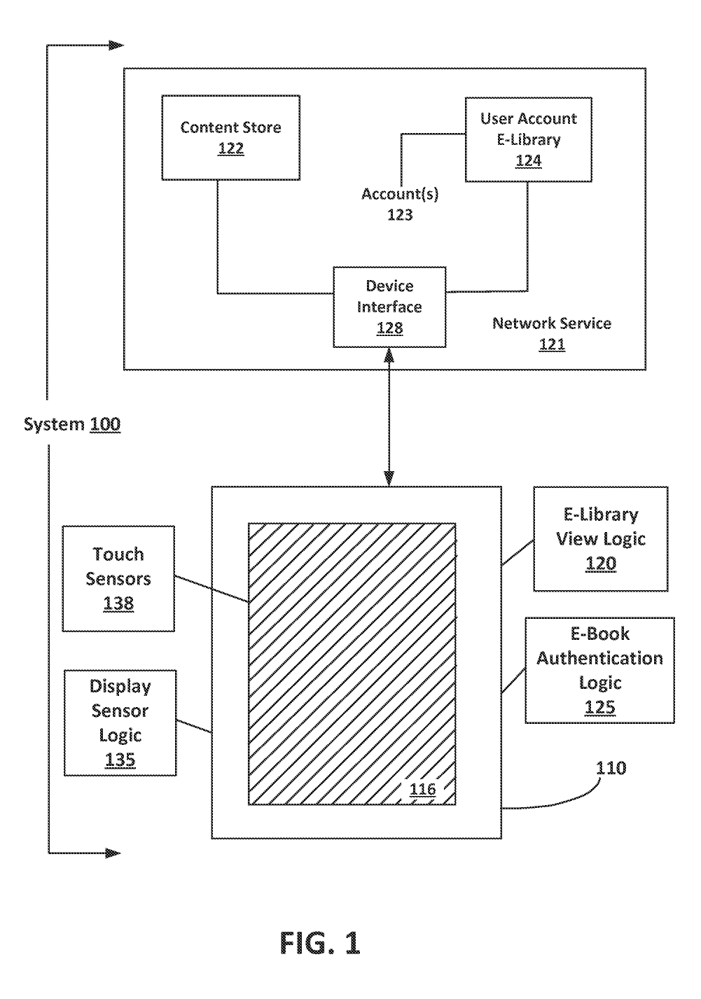

FIG. 1 illustrates a system 100 for utilizing applications and providing e-book services on a computing device, according to an embodiment. In an example of FIG. 1, system 100 includes an electronic personal display device, shown by way of example as an e-reading device 110, and a network service 121. The network service 121 can include multiple servers and other computing resources that provide various services in connection with one or more applications that are installed on the e-reading device 110. By way of example, in one implementation, the network service 121 can provide e-book services that communicate with the e-reading device 110. The e-book services provided through network service 121 can, for example, include services in which e-books are sold, shared, downloaded and/or stored. More generally, the network service 121 can provide various other content services, including content rendering services (e.g., streaming media) or other network-application environments or services.

The e-reading device 110 can correspond to any electronic personal display device on which applications and application resources (e.g., e-books, media files, documents) can be rendered and consumed. For example, the e-reading device 110 can correspond to a tablet or a telephony/messaging device (e.g., smart phone). In one implementation, for example, e-reading device 110 can run an e-reader application that links the device to the network service 121 and enables e-books provided through the service to be viewed and consumed by way of e-reading. In another implementation, the e-reading device 110 can run a media playback or streaming application that receives files or streaming data from the network service 121. By way of example, the e-reading device 110 can be equipped with hardware and software to optimize certain application activities, such as reading electronic content (e.g., e-books). For example, the e-reading device 110 can have a tablet-like form factor, although variations are possible. In some cases, the e-reading device 110 can also have an E-ink display.

In additional detail, the network service 121 can include a device interface 128, a content store 122 and a user account electronic library (e-library) 124 storing e-books or digital content items. Content store 122 may be an online store for purchasing of digital content items for download therefrom onto a resident memory of e-reading device 110 and/or user account e-library 124. User account e-library 124 associates the e-reading device 110 with a user having an account 123. The account 123 can also be associated with ownership of, and/or accessibility to, one or more digital content items stored in content store 122. In one embodiment, the digital content items are e-books, and the content store 122 is an online store having e-books for purchase or other licensed use. The device interface 128 can handle requests from the e-reading device 110 with regard to services and functionality of the network service 121. The device interface 128 can utilize information provided with user account 123 in order to enable services, such as purchasing and downloading of e-books into user account e-library 124, and determining what e-books and content items providable via content store 122 are associated with, and accessible to, user account 123. Additionally, the device interface 128 can provide the e-reading device 110 with access to the on-line content store 122. The device interface 128 can handle input to identify content items (e.g., e-books), and further to link content items to the account 123 of the user.

Yet further, the user account store 124 can retain metadata for individual accounts 123 to identify e-books or other digital content items that have been purchased or made available for consumption for a given account. Thus information relating to e-books within user account e-library 124 can include a metadata set in addition to substantive digital text and image content portions. The metadata set can include, for example, information such as the graphic representation of the e-book 221, such as artwork- or image-based representation of a counterpart physical paper book cover, as well as summary information, author information, title, short synapse or book review, publication date and language of the e-book, and book or volume series information.

The e-reading device 110 may be associated with the user account 123, and multiple devices may be associated with the same account. As described in greater detail below, e-reading device 110 can locally store content items (e.g., e-books) that are purchased or otherwise made available to the user of the e-reading device 110 as well as to archive, in user account 124, e-books and other digital content items that have been purchased for the user account 123, but are not necessarily stored in local resident memory of computing device 110.

With reference to an example of FIG. 1, e-reading device 110 can include a display screen 116. In an embodiment, the display screen 116 is touch-sensitive, to process touch inputs including gestures (e.g., swipes). For example, the display screen 116 may be integrated with one or more touch sensors 138 to provide a touch-sensing region on a surface of the display screen 116. For some embodiments, the one or more touch sensors 138 may include capacitive sensors that can sense or detect a human body's capacitance as input. In the example of FIG. 1, the touch-sensing region coincides with a substantial surface area, if not all, of the display screen 116.

In some embodiments, the e-reading device 110 includes features for providing functionality related to displaying paginated content, including paginated content comprising an e-magazine or e-comic book. The e-reading device 110 can include page transitioning logic, which enables the user to transition through paginated content. The e-reading device 110 can display pages of e-books, e-magazines and e-comics, and enable the user to transition from one page state to another. In particular, an e-book can provide content that is rendered sequentially in pages, and the e-book can display page states in the form of single pages, multiple pages or portions thereof. Accordingly, a given page state can coincide with, for example, a single page, or two or more pages displayed at once. The page transitioning logic can operate to enable the user to transition from a given page state to another page state In the specific example embodiment where a given page state coincides with a single page, for instance, each page state corresponding to one page of the digitally constructed, ordered sequence of pages paginated to comprise, in one embodiment, an e-book. In some implementations, the page transitioning logic enables single page transitions, chapter transitions, or cluster transitions (multiple pages at one time).

According to some embodiments, the e-reading device 110 includes display sensor logic 135 to detect and interpret user input or user input commands made through interaction with the touch sensors 138. By way of example, display sensor logic 135 can detect a user making contact with the touch-sensing region of the display screen 116, otherwise known as a touch event. More specifically, display sensor logic 135 can detect a touch events also referred to herein as a tap, an initial tap held in contact with display screen 116 for longer than some pre-defined threshold duration of time (otherwise known as a “long press” or a “long touch”), multiple taps performed either sequentially or generally simultaneously, swiping gesture actions made through user interaction with the touch sensing region of the display screen 116, or any combination of these gesture actions. Although referred to herein as a “touch” or a tap, it should be appreciated that in some design implementations, sufficient proximity to the screen surface, even without actual physical contact, may register a “contact” or a “touch event”. Furthermore, display sensor logic 135 can interpret such interactions in a variety of ways. For example, each such interaction may be interpreted as a particular type of user input associated with a respective input command, execution of which may trigger a change in state of display 116.

In one implementation, display sensor logic 135 implements operations to monitor for the user contacting or superimposing upon, using a finger, thumb or stylus, a surface of display 116 coinciding with a placement of one or more touch sensor components 138, that is, a touch event, and also detects and correlates a particular gesture (e.g., pinching, swiping, tapping, etc.) as a particular type of input or user action. Display sensor logic 135 may also sense directionality of a user gesture action so as to distinguish between, for example, leftward, rightward, upward, downward and diagonal swipes along a surface portion of display screen 116 for the purpose of associating respective input commands therewith.

E-library view (or interface) logic 120 provides an interface, displayable via display screen 116 of computing device 110, showing titles in a user's e-library collection of e-books, or from a user's home page in relation to an online content store 122 hosting e-books for commercial sale and downloading therefrom. The e-library collection of e-books may be hosted via a remotely located computer server device associate with user account e-library 124, or at a locally resident within a memory at computing device 110. The e-library view logic 120 can display iconic or other graphic representations of individual e-books in the user's e-library collection. For example, the e-library view logic 120 can use the metadata associated with the records of the e-books in the user's e-library account 124 to display lists, folders, or other virtual structures that include graphic representations and/or other identifiers of e-books in the user's collection. The user's collection can include e-books that the user has on the particular device 110 (e.g., locally stored e-books), as well as e-books that are not locally stored, but rather are stored or archived at a remote computer server and associated with the user account e-library 124.

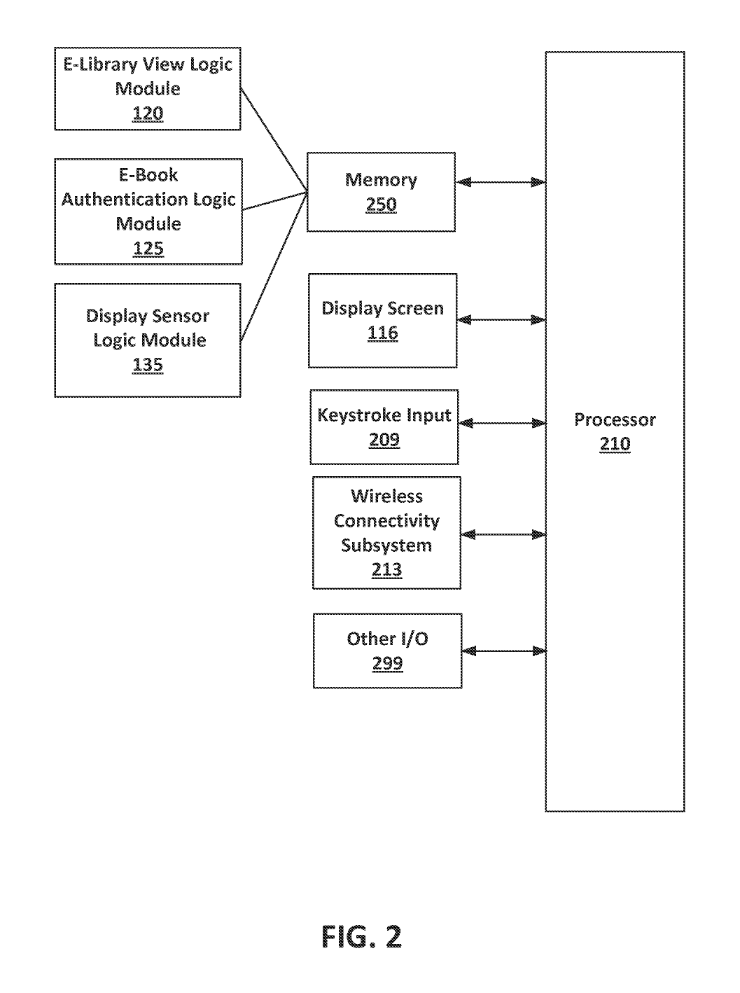

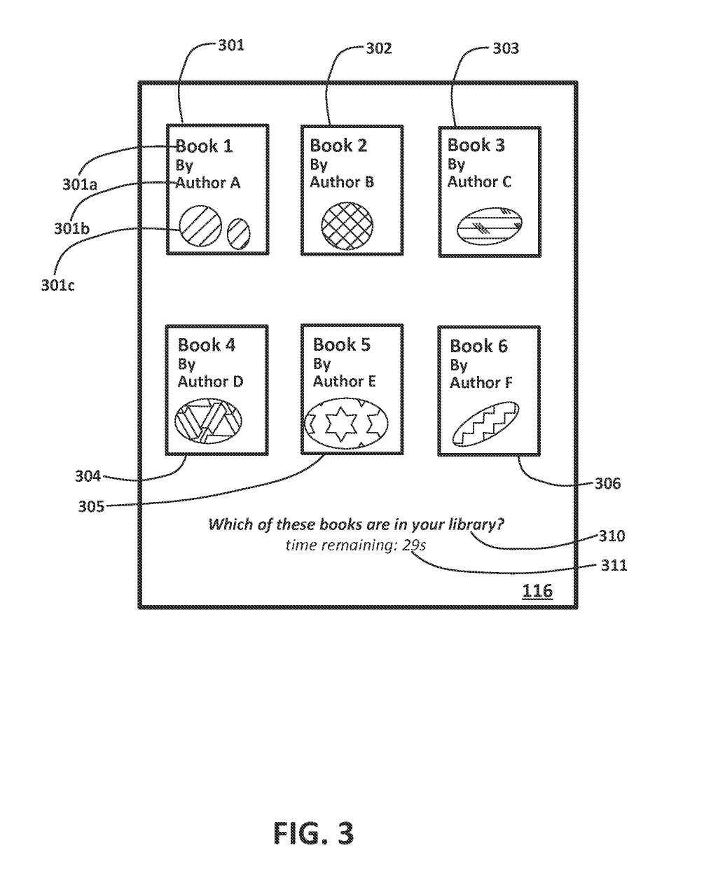

E-book authentication logic module 125 provides an authentication scheme in conjunction with the interface rendered via e-library view logic 120, controlling access via display screen 116 of device 110 to the user e-library account 124 from a locked state thereof, as will be described further in regard to FIGS. 2 and 3.

E-library view logic module 120 and e-book authentication logic module 125 can be implemented as software modules comprising instructions stored in a memory of mobile computing device 110, as described in further detail below with regard to FIG. 2.

One or more embodiments of e-library view logic module 120, display sensor logic 135 and e-book authentication logic module 125 described herein may be implemented using programmatic modules or components. A programmatic module or component may include a program, a subroutine, a portion of a program, or a software or a hardware component capable of performing one or more stated tasks or functions in conjunction with one or more processors. As used herein, a module or component can exist on a hardware component independently of other modules or components. Alternatively, a module or component can be a shared element or process of other modules, programs and hardware components.

Furthermore, the one or more embodiments of e-library view logic module 120, display sensor logic 135 and e-book authentication logic module 125 described herein may be implemented through instructions that are executable by one or more processors. These instructions may be stored on a computer-readable non-transitory medium. In particular, the numerous computing and communication devices shown with embodiments of the invention include processor(s) and various forms of computer memory, including volatile and non-volatile forms, storing data and instructions. Examples of computer-readable mediums include permanent memory storage devices, such as hard drives on personal computers or servers. Other examples of computer storage mediums include portable storage units, flash or solid-state memory (such as included on many cell phones and consumer electronic devices) and magnetic memory. Computers, terminals, network enabled devices (e.g., mobile devices such as cell phones and wearable computers) are all examples of machines and devices that utilize processors, memory, and instructions stored on computer-readable mediums. Additionally, embodiments may be implemented in the form of computer-programs, or a computer usable storage medium capable of storing such a program.

FIG. 2 illustrates a schematic architecture and configuration of a computing device configured for authenticating a user for accessing a locked state e-library account via an e-library view interface, according to an embodiment.

E-reading device 110 further includes processor 210, a memory 250 storing instructions and logic pertaining at least to display sensor logic 135, c-library view logic module 120 and e-book authentication logic 125.

Processor 210 can implement functionality using the logic and instructions stored in memory 250. Additionally, in some implementations, processor 210 communicates with the network service 121 (see FIG. 1). More specifically, the e-reading device 110 can access the network service 121 to receive various kinds of resources (e.g., digital content items such as e-books, configuration files, account information), as well as to provide information (e.g., user account information, service requests etc.). For example, e-reading device 110 can receive application resources, such as e-books or media files, that the user elects to purchase or otherwise download via the network service 121. The application resources that are downloaded onto the e-reading device 110 can be stored in memory 250.

In some implementations, display 116 can correspond to, for example, a liquid crystal display (LCD) or light emitting diode (LED) display that illuminates in order to provide content generated from processor 210. In some implementations, display 116 can be touch-sensitive. For example, in some embodiments, one or more of the touch sensor components 138 may be integrated with display 116. In other embodiments, the touch sensor components 138 may be provided (e.g., as a layer) above or below display 116 such that individual touch sensor components 138 track different regions of display 116. Further, in some variations, display 116 can correspond to an electronic paper type display, which mimics conventional paper in the manner in which content is displayed. Examples of such display technologies include electrophoretic displays, electro-wetting displays, and electro-fluidic displays.

Processor 210 can receive input from various sources, including touch sensor components 138, display 116, keystroke input 208 such as from a virtual or rendered keyboard, and other input mechanisms 299 (e.g., buttons, mouse, microphone, etc.). With reference to examples described herein, processor 210 can respond to input detected at the touch sensor components 138. In some embodiments, processor 210 responds to inputs from the touch sensor components 138 in order to facilitate or enhance c-book activities such as generating e-book content on display 116, performing page transitions of the displayed e-book content, powering off the device 110 and/or display 116, activating a screen saver, launching or closing an application, and/or otherwise altering a state of display 116.

In some embodiments, memory 250 may store display sensor logic 135 that monitors for user interactions detected through the touch sensor components 138, and further processes the user interactions as a particular input or type of input. In an alternative embodiment, display sensor logic module 135 may be integrated with the touch sensor components 138. For example, the touch sensor components 138 can be provided as a modular component that includes integrated circuits or other hardware logic, and such resources can provide some or all of display sensor logic 135. In variations, some or all of display sensor logic 135 may be implemented with processor 210 (which utilizes instructions stored in memory 250), or with an alternative processing resource.

E-reading device 110 further includes wireless connectivity subsystem 213, comprising a wireless communication receiver, a transmitter, and associated components, such as one or more embedded or internal antenna elements, local oscillators, and a processing module such as a digital signal processor (DSP) (not shown). As will be apparent to those skilled in the field of communications, the particular design of wireless connectivity subsystem 213 depends on the communication network in which computing device 110 is intended to operate, such as in accordance with Wi-Fi, Bluetooth, Near Field Communication (NFC) communication protocols, and the like.

E-library view logic module 120 can be implemented as a software module, comprising instructions stored in memory 250, on mobile computing device 110. In one implementation, the local memory 250 can include records for each e-book in the user's e-library account 124, each record include metadata of the e-books therein. The user may have the content portion of select e-books archived remotely at a computer server cloud system, so as not to reside in the local memory 250, but be provided by the network service 121 upon request or as needed. By way of example, the e-library view logic module 120 can display the e-books of a user's collection in the form of a virtual bookshelf or bookcase feature showing graphical icons representing the e-books. In such an implementation, the e-books are displayed as icons that include imagery, title information, etc. In a variation, the e-library view module 120 can display representations of e-books in the user's collection as icons, or as icons with associated text. Still further, folders can be used to provide a panel view of the graphic representations (e.g., icons and/or text) of the e-books 325 in the user's collection, corresponding to a side view of a bookshelf showing book spines with titles printed thereon for identifying individual books.

E-book authentication logic 125 can be implemented as a software module comprising instructions stored in memory 250 of computing device 110. E-book authentication logic module 125 provides a security authentication scheme enabling access via touchscreen display 116 to the user e-library account 124, whenever user e-library account 124 is in a locked state. The authentication scheme randomly intersperses c-books particular to user account e-library 124 among a selection of e-books not contained therein, but rather are available via content store 122.

In conjunction with e-library view module 120, icons representative of both e-library and non-e-library/content store e-books are rendered at touchscreen display 116 of computing device 110. In one embodiment, user input is required to correctly identify those e-books belonging to their e-library collection by enacting a touch event or input upon icons representing those specific e-books, in order for the user to successfully access their e-library account.

FIG. 3 illustrates an example configuration for operation in authenticating a user for accessing a locked state e-library account 124 via an e-library view interface 120, according to an embodiment, showing a view of touchscreen display 116 rendered via e-library view logic 120 in response to a device power on input action, or a wake from sleep mode action initiated by a user at computing device 110.

Icons representing e-books 301-306 are rendered at display screen 116. Graphical icon 301 representing e-book 301 may include book title 301a, author information 301b and artwork or imagery 301c corresponding to a counterpart physical paper book as published and such as may be displayed at a retail outlet for sale. Corresponding information of e-books 302-306 may be displayed within the respective graphical icons 302-306. In an embodiment, e-books 302 and 305, for instance, are associated with, and sourced from, user account e-library 124, while in contrast e-books 303, 304 and 306 are not associated therewith, but rather, are sourced randomly from the wider population of e-books made available for sale and download via online content store 122.

Still in regard to FIG. 3, e-book authentication logic 125 may provide an invite via notification 310 for the user to identify and select the e-books that belong to user account e-library 124, which the user must fulfill within a limited number of tries before being granted access thereto. E-book authentication logic 125 may provide time remaining 211 for the user in one embodiment. While in an embodiment depicted, the notification is in the form of a question (“Which of these books belong to your library?”), it is contemplated that in alternate manifestations, an instruction may be provided in lieu thereof, such as “Identify which of these e-books belong to your library”. The user may then proceed to enact a touch event, such as a tap or a swipe, upon the respective graphical icons 302 and 305 in the embodiment described above, as prerequisite to accessing user account e-library 124.

In a further embodiment, advantageous to discovery of new e-books for potential purchase by the user, a long press action, in one embodiment, enacted upon any of non-e-library collection of e-book icons 301, 303, 304 and 306 may present further information stored in accordance with metadata of the respective e-book stored at content store 122, such as a book review or a book synapse, or book price information.

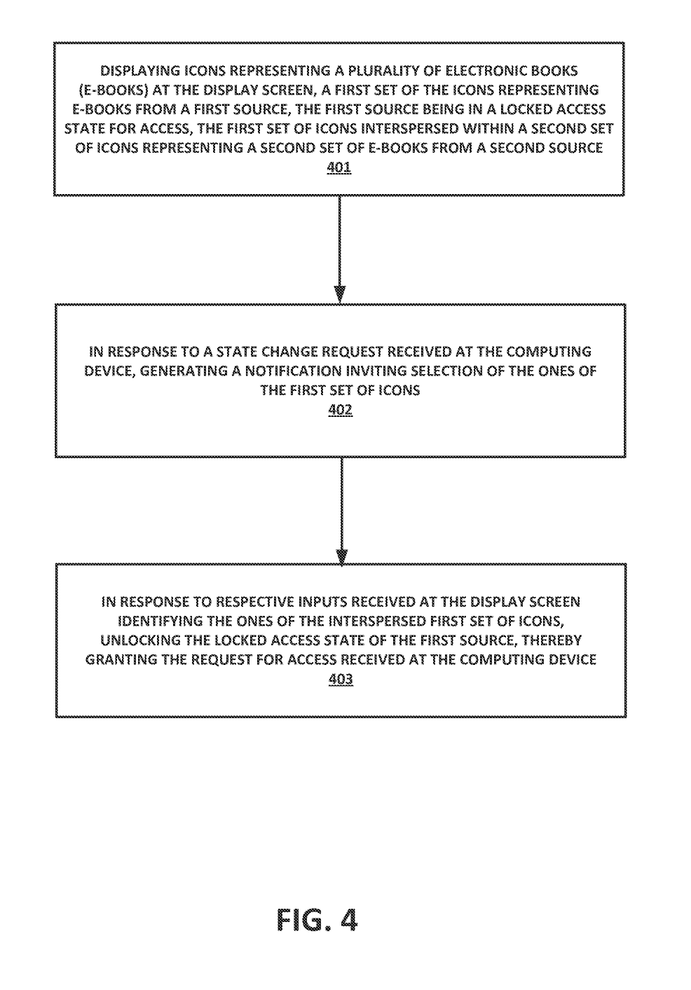

Next with reference to FIG. 4, illustrated is a method for authenticating a device user for access to an e-library account for e-reading on computer device 110 having touchscreen display 116, according to an embodiment. In describing the example of FIG. 4, reference will be made to components such as described with regard to FIGS. 1 through 3 for purposes of illustrating components for performing a step or sub-step as described.

At step 401, displaying icons representing a plurality of electronic books (e-books) 301-306 at the display screen 116, a first set of the icons 302, 305 representing respective ones of a first set of e-books sourced from user account e-library 124, the user account e-library 124 being in a locked access state relative to a request for access received at the computing device 110, the first set of the icons being interspersed within a second set of the icons 301, 303, 304, 306 representing respective ones of a second set of e-books sourced from a content store 122.

At step 402, in response to a state change request received at the computing device 110, generating a notification 310 inviting selection of the ones of the first set of icons 302, 305.

At step 403 in response to respective inputs received at the display screen 116 identifying the ones of the first set of icons 302, 305, unlocking the locked access state of the user account e-library 122 thereby to grant the request for access received at the computing device 110.

Although illustrative embodiments have been described in detail herein with reference to the accompanying drawings, variations to specific embodiments and details are contemplated and encompassed by this disclosure. It is intended that the scope of embodiments described herein be defined by claims and their equivalents. Furthermore, it is contemplated that a particular feature described, either individually or as part of an embodiment, can be combined with other individually described features, or parts of other embodiments. Thus, absence of describing combinations should not preclude the inventor(s) from claiming rights to such combinations.

What is claimed is:

1. A method executed in a processor of a computing device, the computing device further including a memory storing instructions and a display screen having touch functionality, the method comprising:
displaying icons representing a plurality of electronic books (e-books) at the display screen, a first set of the icons representing respective ones of a first set of e-books from a first source, the first source being in a locked access state relative to a request for access received at the computing device, the first set of the icons being interspersed within a second set of the icons representing respective ones of a second set of e-books from a second source;
in response to a state change request received at the computing device, generating a notification inviting selection of the ones of the first set of icons; and
in response to respective inputs received at the display screen identifying the ones of the interspersed first set of icons, unlocking the locked access state of the first source to grant the request for access received at the computing device;
whereby the computing device accesses information hosted at the first source.

2. The method of claim 1 wherein the first source comprises an electronic library (e-library) including a collection of e-books.

3. The method of claim 2 wherein the information accessed from the e-library includes metadata of respective e-books of the collection hosted at the first source.

4. The method of claim 2 wherein the e-library is hosted at one of: a remotely located computer server device and the memory of the computing device.

5. The method of claim 1 wherein the inputs received at the display screen identifying the ones of the interspersed first set of the icons comprise respective touch events enacted upon the display screen.

6. The method of claim 1 wherein the notification inviting selection of the ones of the first set of icons is one of: a query and an instruction.

7. The method of claim 1 wherein the state change request is an input command received at the computing device, the input command consisting of one of: a device power on and a device wake up from sleep mode.

8. The method of claim 1 wherein the display icons comprise cover artwork and text correspondingly rendered on as-published physical book counterparts of respective ones of the plurality of e-books.

9. The method of claim 1 wherein the second source is an online store of e-books made available for commercial sale online, and the second set of e-books are randomly selected therefrom for presentation at the display screen of the computing device.

10. The method of claim 1 further comprising presenting metadata-related information associated with ones of the second set of e-books in response to a long press touchscreen input action enacted upon a respective display icon thereof.

11. A computer-readable medium that stores instructions for a computing device, the computing device including a processor, a memory and a display screen having touch functionality, the instructions being executable by the processor to cause the computing device to perform operations that include:
displaying icons representing a plurality of electronic books (e-books) at the display screen, a first set of the icons representing respective ones of a first set of e-books from a first source, the first source being in a locked access state relative to a request for access received at the computing device, the first set of icons interspersed within a second set of icons representing respective ones of a second set of e-books from a second source;
in response to a state change request received at the computing device, generating a notification inviting selection of the ones of the first set of icons; and
in response to respective inputs received at the display screen identifying the ones of the interspersed first set of icons, unlocking the locked access state of the first source to grant the request for access received at the computing device;
whereby the computing device accesses information hosted at the first source.

12. A computing device comprising:
a memory that stores a set of instructions;
a display screen having touch functionality;
a processor that access the instructions in memory, the processor further configured to:
display icons representing a plurality of electronic books (e-books) at the display screen, a first set of the icons representing respective ones of a first set of e-books from a first source, the first source being in a locked access state relative to a request for access received at the computing device, the first set of icons interspersed within a second set of icons representing respective ones of a second set of e-books from a second source;
in response to a state change request received at the computing device, generate a notification inviting selection of the ones of the first set of icons; and
in response to respective inputs received at the display screen identifying the ones of the interspersed first set of icons, unlock the locked access state of the first source to grant the request for access received at the computing device;
whereby the computing device accesses information hosted at the first source.

13. The computing device of claim 12 wherein the first source comprises an electronic library (e-library) including a collection of e-books.

14. The computing device of claim 13 wherein the information accessed from the e-library includes metadata of respective e-books of the collection hosted at the first source.

15. The computing device of claim 12 wherein the e-library is hosted at one of: a remotely located computer server device and the memory of the computing device.

16. The computing device of claim 12 wherein the inputs received at the display screen identifying the ones of the interspersed first set of the icons comprise respective touch events enacted upon the display screen.

17. The computing device of claim 12 wherein the state change request is an input command received at the computing device, the input command consisting of one of: a device power on and a device wake up from sleep mode.

18. The computing device of claim 12 wherein the display icons comprise cover artwork and text correspondingly rendered on as-published paper book counterparts of respective ones of the plurality of e-books.

19. The computing device of claim 12 wherein the second source is an online store of e-books made available for commercial sale online, and the second set of e-books are randomly selected therefrom for presentation at the display screen of the computing device.

20. The computing device of claim 12 further comprising presenting metadata-related information associated with ones of the second set of e-books in response to a long press touchscreen input action enacted upon a respective display icon thereof.
